(19) United States
(12) Patent Application Publication
(10) Pub. No.: US 2019/0197411 A1
(43) Pub. Date: Jun. 27, 2019

(54) CHARACTERIZING MODEL PERFORMANCE USING GLOBAL AND LOCAL FEATURE CONTRIBUTIONS

(71) Applicant: Microsoft Technology Licensing, LLC, Redmond, WA (US)

(72) Inventors: Wei Di, Cupertino, CA (US); Songtao Guo, Cupertino, CA (US)

(73) Assignee: Microsoft Technology Licensing, LLC, Redmond, WA (US)

(21) Appl. No.: 15/851,123

(22) Filed: Dec. 21, 2017

(51) Int. Cl. G06N 5/02; G06N 99/00

(52) U.S. Cl. CPC G06N 5/02; G06N 99/005

(57) ABSTRACT

The disclosed embodiments provide a system for processing data. During operation, the system obtains a set of coefficients from a linear model that uses a set of features inputted into a statistical model to estimate an output of the statistical model. Next, the system combines the set of coefficients with a set of feature values of the features to calculate a set of local contributions of the features toward the output of the statistical model, wherein each local contribution in the set of local contribution is calculated by multiplying each feature value in the set of feature values by a coefficient for a corresponding feature in the linear model. The system then outputs, based on a first ranking of the set of features by the set of local contributions, a first subset of the features for use in characterizing a local performance of the statistical model.

### BACKGROUND

### Field

The disclosed embodiments relate to statistical model performance. More specifically, the disclosed embodiments relate to techniques for performing hybrid characterization of model performance using global and local feature contributions.

### Related Art

Analytics may be used to discover trends, patterns, relationships, and/or other attributes related to large sets of complex, interconnected, and/or multidimensional data. In turn, the discovered information may be used to gain insights and/or guide decisions or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of statistical models. The discovered information may then be used to guide decisions and/or perform actions related to the data. For example, the output of a statistical model may be used to guide marketing decisions, assess risk, detect fraud, predict behavior, and/or customize or optimize use of an application or website.

However, significant time, effort, and overhead may be spent on feature selection during creation and training of statistical models for analytics. For example, a data set for a statistical model may have thousands to millions of features, including features that are created from combinations of other features, while only a fraction of the features and/or combinations may be relevant and/or important to the statistical model. At the same time, training and/or execution of statistical models with large numbers of features typically require more memory, computational resources, and time than those of statistical models with smaller numbers of features. Excessively complex statistical models that utilize too many features may additionally be at risk for overfitting.

At the same time, statistical models are commonly associated with a tradeoff between interpretability and performance. For example, a linear regression model may include coefficients that identify the relative weights or importance of features in the model but does not perform well with complex problems. Conversely, a nonlinear model such as a random forest or gradient boosted trees can be trained to perform well with a variety of problems but typically operates in a way that is not easy to understand.

Consequently, creation and use of statistical models in analytics may be facilitated by mechanisms for efficiently and effectively performing feature selection and interpretation for the statistical models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

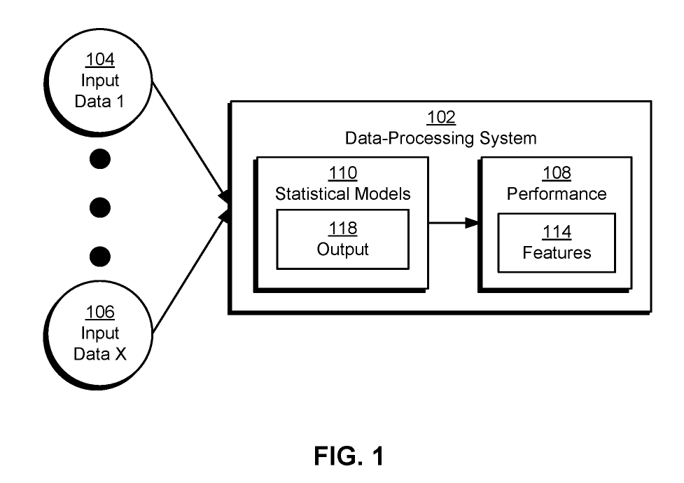

The disclosed embodiments provide a method, apparatus, and system for processing data. As shown in FIG. 1, the system may be a data-processing system 102 that analyzes one or more sets of input data (e.g., input data 1 104, input data x 106). More specifically, data-processing system 102 may create and train one or more statistical models 110 for analyzing input data related to users, organizations, applications, job postings, purchases, electronic devices, network devices, images, audio, video, websites, content, sensor measurements, and/or other categories. Statistical models 110 may include, but are not limited to, regression models, artificial neural networks, support vector machines, decision trees, random forests, boosted gradient trees, naïve Bayes classifiers, Bayesian networks, deep learning models, hierarchical models, and/or ensemble models.

Analysis performed by data-processing system 102 may be used to discover relationships, patterns, and/or trends in the data; gain insights from the input data; and/or guide decisions or actions related to the data. For example, data-processing system 102 may use statistical models 110 to generate output 118 that includes scores, classifications, recommendations, estimates, predictions, and/or other inferences or properties. Output 118 may be inferred or extracted from features 114 in the input data, including primary features and/or derived features that are generated from primary features and/or other derived features.

For example, the primary features may include profile data, user activity, sensor data, and/or other data that is extracted directly from fields or records in the input data. The primary features may be aggregated, scaled, combined, bucketized, and/or otherwise transformed to produce derived features, which in turn may be further combined or transformed with one another and/or the primary features to generate additional derived features. After output is generated from one or more sets of primary and/or derived features, the output may be queried and/or used to improve revenue, interaction with the users and/or organizations, use of the applications and/or content, and/or other metrics associated with the input data.

In one or more embodiments, features 114 are obtained and/or used with an online professional network or other community of users that is used by a set of entities to interact with one another in a professional, social, and/or business context. The entities may include users that use the online professional network to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

As a result, features 114 may include member features, company features, and/or job features. The member features include attributes from the members' profiles with the online professional network, such as each member's title, skills, work experience, education, seniority, industry, location, and/or profile completeness. The member features also include each member's number of connections in the social network, the member's tenure on the social network, and/or other metrics related to the member's overall interaction or “footprint” in the online professional network. The member features further include attributes that are specific to one or more features of the online professional network, such as a classification of the member as a job seeker or non-job-seeker.

The member features may also characterize the activity of the members with the online professional network. For example, the member features may include an activity level of each member, which may be binary (e.g., dormant or active) or calculated by aggregating different types of activities into an overall activity count and/or a bucketized activity score. The member features may also include attributes (e.g., activity frequency, dormancy, total number of user actions, average number of user actions, etc.) related to specific types of social or online professional network activity, such as messaging activity (e.g., sending messages within the social network), publishing activity (e.g., publishing posts or articles in the social network), mobile activity (e.g., accessing the social network through a mobile device), job search activity (e.g., job searches, page views for job listings, job applications, etc.), and/or email activity (e.g., accessing the social network through email or email notifications).

The company features include attributes and/or metrics associated with companies. For example, company features for a company may include demographic attributes such as a location, an industry, an age, and/or a size (e.g., small business, medium/enterprise, global/large, number of employees, etc.) of the company. The company features may further include a measure of dispersion in the company, such as a number of unique regions (e.g., metropolitan areas, counties, cities, states, countries, etc.) to which the employees and/or members of the online professional network from the company belong.

A portion of company features may relate to behavior or spending with a number of products, such as recruiting, sales, marketing, advertising, and/or educational technology solutions offered by or through the online professional network. For example, the company features may also include recruitment-based features, such as the number of recruiters, a potential spending of the company with a recruiting solution, a number of hires over a recent period (e.g., the last 12 months), and/or the same number of hires divided by the total number of employees and/or members of the online professional network in the company. In turn, the recruitment-based features may be used to characterize and/or predict the company's behavior or preferences with respect to one or more variants of a recruiting solution offered through and/or within the online professional network.

The company features may also represent a company's level of engagement with and/or presence on the online professional network. For example, the company features may include a number of employees who are members of the online professional network, a number of employees at a certain level of seniority (e.g., entry level, mid-level, manager level, senior level, etc.) who are members of the online professional network, and/or a number of employees with certain roles (e.g., engineer, manager, sales, marketing, recruiting, executive, etc.) who are members of the online professional network. The company features may also include the number of online professional network members at the company with connections to employees of the online professional network, the number of connections among employees in the company, and/or the number of followers of the company in the online professional network. The company features may further track visits to the online professional network from employees of the company, such as the number of employees at the company who have visited the online professional network over a recent period (e.g., the last 30 days) and/or the same number of visitors divided by the total number of online professional network members at the company.

One or more company features may additionally be derived features that are generated from member features. For example, the company features may include measures of aggregated member activity for specific activity types (e.g., profile views, page views, jobs, searches, purchases, endorsements, messaging, content views, invitations, connections, recommendations, advertisements, etc.), member segments (e.g., groups of members that share one or more common attributes, such as members in the same location and/or industry), and companies. In turn, the company features may be used to glean company-level insights or trends from member-level online professional network data, perform statistical inference at the company and/or member segment level, and/or guide decisions related to business-to-business (B2B) marketing or sales activities.

The job features describe and/or relate to job listings and/or job recommendations within the online professional network. For example, the job features may include declared or inferred attributes of a job, such as the job's title, industry, seniority, desired skill and experience, salary range, and/or location. One or more job features may also be derived features that are generated from member features and/or company features. For example, the job features may provide a context of each member's impression of a job listing or job description. The context may include a time and location (e.g., geographic location, application, website, web page, etc.) at which the job listing or description is viewed by the member. In another example, some job features may be calculated as cross products, cosine similarities, statistics, and/or other combinations, aggregations, scaling, and/or transformations of member features, company features, and/or other job features.

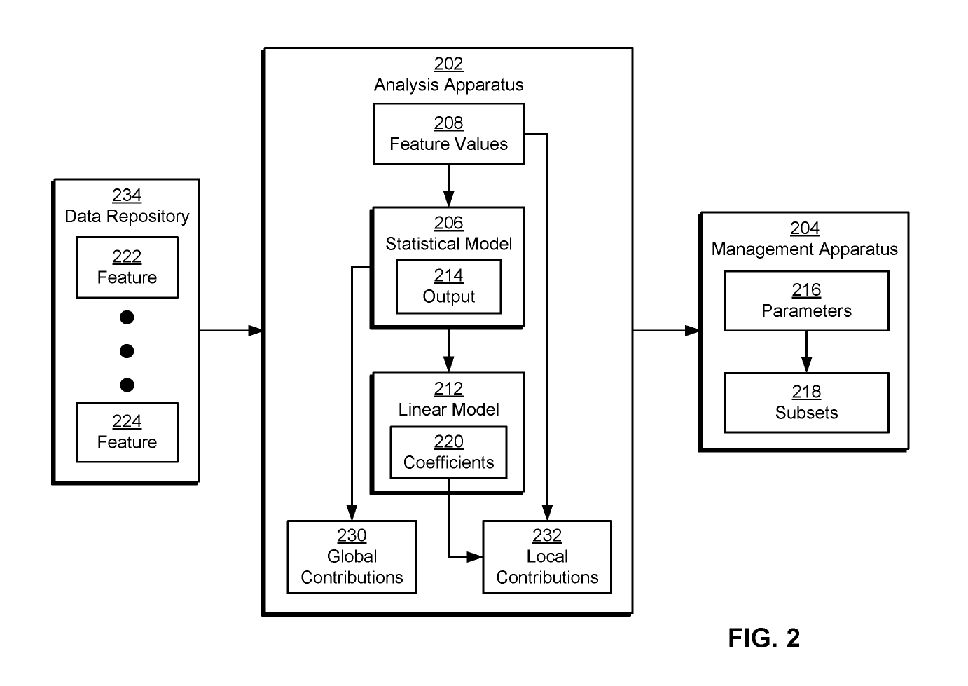

In one or more embodiments, data-processing system 102 includes functionality to characterize a performance 108 of statistical models 110 using features 114 inputted into statistical models 110. In addition, performance 108 may include the global behavior of each statistical model across a set of predictions, scores, and/or inferences made by the statistical model, as well as the local behavior of each statistical model with respect to a specific prediction, score, and/or inference. As shown in FIG. 2, a system for processing data (e.g., data-processing system 102 of FIG. 1) may include an analysis apparatus 202 and a management apparatus 204. Each of these components is described in further detail below.

Analysis apparatus 202 performs processing related to characterizing the performance or operation of a statistical model 206. For example, analysis apparatus 202 may obtain statistical model 206 as a regression model, artificial neural network, naïve Bayes classifier, Bayesian network, clustering technique, decision tree, random forest, gradient boosted tree, support vector machine, and/or other type of machine learning model or technique. Output 214 of statistical model 206 may be used to perform prediction, classification, scoring, recommendation, estimation, and/or other tasks. For example, statistical model 206 may generate scores that represent propensities of users in performing an action and/or of customers in purchasing a product.

As shown in FIG. 2, statistical model 206 may be trained and/or executed using feature values 208 from multiple features 222-224. For example, features 222-224 used by statistical model 206 to predict a spending behavior and/or churn risk of a customer with a product may include demographic attributes, historic spending behavior, product usage attributes, and/or other attributes that characterize the customer and/or the customer's behavior with respect to the product.

Features 222-224 and/or feature values 208 may be stored in a database, data store, distributed filesystem, messaging service, and/or another type of data repository 234. During training, statistical model 206 may be fit to training data that includes a subset of feature values 208 from data repository 234. Statistical model 206 may then be validated and/or tested using validation and/or test data that include one or more additional subsets of feature values 208. Finally, statistical model 206 may be applied to unseen data containing new and/or remaining subsets of feature values 208 in data repository 234 to generate output 214 that infers properties associated with features 222-224.

In one or more embodiments, the system of FIG. 2 includes functionality to perform analysis and interpretation of the performance of statistical model 206 using a hybrid approach that combines global contributions 230 and local contributions 232 of features 222-224 and/or feature values 208 inputted into statistical model 206. Global contributions 230 may represent the global effects of individual features 222-224 on multiple output 214 values from statistical model 206, while local contributions 232 may represent the local effects of features 222-224 on individual output 214 values from statistical model 206. For example, global contributions 230 may characterize the effects of features 222-224 on multiple predictions of customer spending or churn risk from statistical model 206 (e.g., all predictions from statistical model 206 or predictions for a given subset of customers). On the other hand, a different set of local contributions 232 may be generated for each prediction to identify specific features 222-224 that affect that prediction.

First, analysis apparatus 202 uses multiple sets of feature values 208 and the corresponding output 214 values from statistical model 206 to build a linear model 212 that estimates values of output 214 based on the corresponding feature values 208. For example, analysis apparatus 202 may use feature values 208 inputted into statistical model 206 to train an additive linear model 212 so that the output of linear model 212 estimates output 214 of statistical model 206.

Second, analysis apparatus 202 uses coefficients 220 of linear model 212, sets of feature values 208 inputted into statistical model 206, and/or measures of feature importance associated with statistical model 206 to characterize the performance or output 214 of statistical model 206. In particular, analysis apparatus 202 uses measures of feature importance from statistical model 206 to assess the relative global contributions 230 of features 222-224 toward output 214 of statistical model 206. For example, statistical model 206 may have the following linear representation:

y=β₁x₁+β₂x₂+ . . . +βₙxₙ+β₀

In the above equation, x₁, x₂, . . . , xₙ represent features 222-224 inputted into statistical model 206 and linear model 212, and β₁, β₂, . . . βₙ represent coefficients (e.g., coefficients 220) associated with features 222-224. The coefficients may be obtained directly from a linear statistical model 206, or the coefficients may include weights representing the relative importance of the features in nonlinear models, such as random forest impurity decreases. Thus, a feature with a higher coefficient and/or weight may have a greater linear effect on output 214 than a feature with a lower coefficient and/or weight.

Analysis apparatus 202 also combines coefficients 220 and feature values 208 to assess the relative local contributions 232 of features 222-224 toward individual values of output 214. Continuing with the previous example, analysis apparatus 202 may determine local contributions 232 for a given output 214 value from statistical model 206 using the following:

cᵢ=βᵢxᵢ

In the above equation, each local contribution cᵢ may be calculated by multiplying the corresponding coefficient β₁ with the corresponding feature value xᵢ used to produce the output value.

After global contributions 230 are obtained from measures of feature importance in statistical model 206 and local contributions 232 are determined using coefficients 220 of linear model 212 multiplied with the corresponding feature values 208 inputted into statistical model 206, management apparatus 204 selects subsets 218 of features 222-224 associated with significant global contributions 230 and significant local contributions 232 toward output 214 for use in characterizing the performance of statistical model 206. For example, management apparatus 204 may rank features 222-224 in descending order of global contributions 230 (i.e., coefficients 220 of linear model 212) and select a first subset of features with the highest global contributions 230 from the ranking. Similarly, management apparatus 204 may rank features 222-224 in descending order of local contributions 232 for a given set of feature values 208 inputted into statistical model 206 (i.e., coefficients 220 multiplied by feature values 208) and select a second subset of features with the highest local contributions 232 from the ranking.

In one or more embodiments, management apparatus 204 selects subsets 218 of features 222-224 associated with significant global contributions 230 and significant local contributions 232 based on one or more parameters 216 used to determine the number of features to be included in each subset. First, management apparatus 204 may select subsets 218 of highest-ranked features in global contributions 230 and/or local contributions 232 based on one or more parameters 216 that specify proportions associated with each subset. For example, management apparatus 204 may obtain a user-generated and/or fixed parameter that specifies that 30% of features 222-224 used to characterize the performance of statistical model 206 have high global contributions 230 to output 214. Thus, 10 features that are selected as factors for characterizing a given output 214 of statistical model 206 may include three features with the highest global contributions 230 to output 214 (i.e., the highest coefficients 220 in linear model 212).

Second, management apparatus 204 may select subsets 218 of features 222-224 associated with significant global contributions 230 and significant local contributions 232 based on one or more parameters 216 for placing features in either subset and/or selecting one subset before another. For example, parameters 216 may specify that five features with high global contributions 230 be selected before 10 features with high local contributions 232. Thus, a feature that is associated with both a high global contribution and a high local contribution for a given output 214 of statistical model 206 may be included in the five features with high global contributions 230 and omitted from the remaining 10 features with high local contributions 232. In turn, the remaining 10 features with high local contributions 232 may omit features that are already included in the five features with the highest global contributions 230 to output 214.

Management apparatus 204 then outputs the selected subsets 218 of features 222-224 and attributes associated with the selected features 222-224 for use in characterizing the behavior, performance, and/or output 214 of statistical model 206. For example, management apparatus 204 may output feature names, feature namespaces, feature sources, feature values 208, coefficients 220, products of coefficients 220 and feature values 208, and/or other data associated with subsets 218 of features 222-224 selected to have the highest global contributions 230 and local contributions 232 toward a given output 214 value generated by statistical model 206. The output may be included in a table, chart, spreadsheet, visualization, file, message, notification, and/or other human-readable form.

Management apparatus 204 may also output statistics and/or metrics associated with subsets 218 of features 222-224 with high global contributions 230 and local contributions 232 toward a given output 214 value generated by statistical model 206. For example, management apparatus 204 may calculate the proportional “weight” of each feature with a high global contribution by dividing the coefficient for the feature from linear model 212 by the sum of all coefficients 220 from linear model 212. Management apparatus 204 may then output the weight in lieu of or in addition to the coefficient of the feature. In another example, management apparatus 204 may determine a percentile or quantile associated with a feature value for a feature with a high local contribution toward a given output 214 value from statistical model 206. Management apparatus 204 may then output the percentile or quantile to assist in the interpretation of the feature value's position in a distribution of feature values for the feature.

In turn, administrators, developers, data scientists, researchers, and/or other users associated with developing, maintaining, and/or using features 222-224 and/or statistical model 206 may use output from management apparatus 204 to interpret and/or understand scores, predictions, inferences, and/or other behavior or output 214 from statistical model 206. For example, the users may use the outputted subsets 218 of features 222-224 and/or the associated attributes to better understand and/or validate the behavior of statistical model 206. The users may also, or instead, identify key feature values for an entity that affect a corresponding output 214 value from statistical model 206 (e.g., a certain type of behavior that increases a customer's risk of churning from a product) and use insights associated with the feature values to guide decisions or actions for maintaining or adjusting output 214 for the entity (e.g., interacting with the customer in a way that reduces that type of behavior and/or the customer's risk or churning).

By using a single linear model 212 and feature values 208 of features 222-224 inputted into statistical model 206 to characterize the behavior or performance of statistical model 206, the system of FIG. 2 may interpret specific output 214 values of statistical model 206 with respect to individual sets of feature values 208 used to generate those output values. On the other hand, conventional model-interpretation techniques may interpret the local behavior of a statistical model by fitting a separate linear model to each set of feature values and corresponding output value generated from the set of feature values, which may incur significant computational overhead and fail to scale with the amount of output 214 generated by statistical model 206. Consequently, the system may improve the computational efficiency associated with characterizing local statistical model behavior while providing additional context for understanding global statistical model behavior, thereby improving technologies and computer systems used in developing and using statistical models and features.

Those skilled in the art will appreciate that the system of FIG. 2 may be implemented in a variety of ways. First, analysis apparatus 202, management apparatus 204, and/or data repository 234 may be provided by a single physical machine, multiple computer systems, one or more virtual machines, a grid, one or more databases, one or more filesystems, and/or a cloud computing system. Analysis apparatus 202 and management apparatus 204 may additionally be implemented together and/or separately by one or more hardware and/or software components and/or layers.

Second, feature values 208, output 214, coefficients 220, global contributions 230, local contributions 232, and/or other data used by the system may be stored, defined, and/or transmitted using a number of techniques. For example, the system may be configured to accept features from different types of repositories, including relational databases, graph databases, data warehouses, filesystems, and/or flat files. The system may also obtain and/or transmit feature names, feature namespaces, feature sources, feature values 208, output 214, coefficients 220, global contributions 230, local contributions 232, and/or other data used to characterize the performance of statistical model 206 in a number of formats, including database records, property lists, Extensible Markup language (XML) documents, JavaScript Object Notation (JSON) objects, and/or other types of structured data.

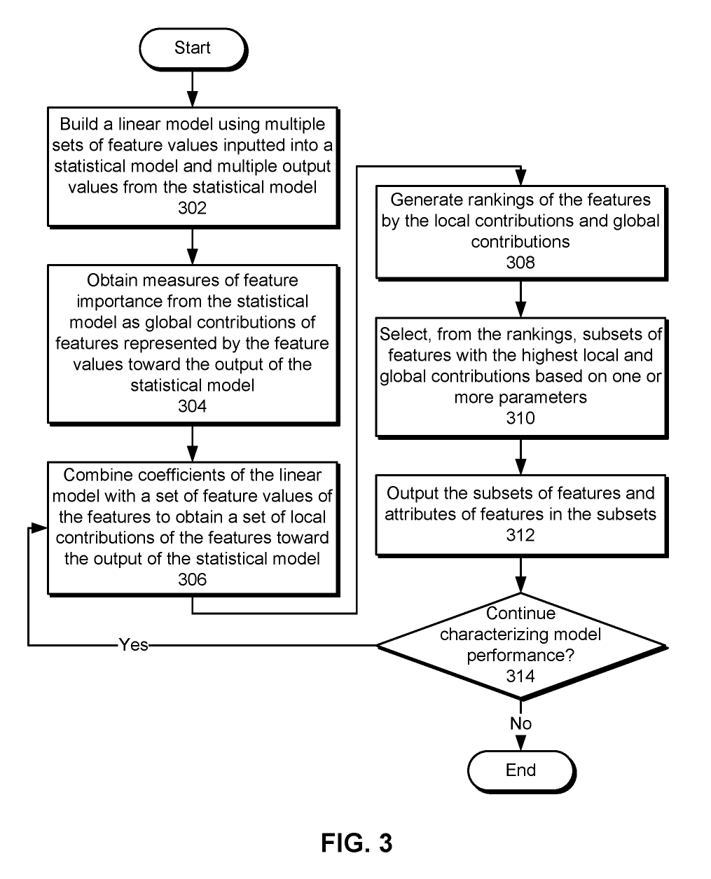

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a linear model is built using multiple sets of feature values of features inputted into a statistical model and multiple output values from the statistical model (operation 302). For example, the linear model may be trained using the feature values to estimate the output of the statistical model. Next, measures of feature importance from the statistical model are obtained as global contributions of features represented by the feature values toward the output of the statistical model (operation 304). As a result, a larger measure of feature importance (e.g., linear model coefficient, feature weight, random forest impurity decrease, etc.) may represent a higher contribution of the corresponding feature toward the output of the statistical model, and a smaller measure of feature importance may represent a lower contribution of the corresponding feature toward the output generated by the statistical model.

The coefficients are also combined with a set of feature values of the features to obtain a set of local contributions of the features toward the output of the statistical model (operation 306). For example, the local contributions may represent the effect of a specific set of feature values on a specific output value generated by the statistical model. As a result, the local contribution of each feature may be determined by multiplying a variable feature value of the feature by the corresponding fixed coefficient from the linear model.

Rankings of the features by the local contributions and global contributions are generated (operation 308), and subsets of features with the highest local and global contributions are selected from the rankings based on one or more parameters (operation 310). For example, the subsets of features may be selected based on a parameter that specifies a percentage or proportion (e.g., 30%, ⅕^{th}, 0.25, etc.) of the number of features to be included in one or both subsets. In another example, the subsets of features may be selected based on a parameter that places a feature in the first or second subset and/or specifies selection of one subset of features before the other. As a result, a feature that is ranked highly in both the local and global contributions may be selected for inclusion in the first subset and excluded from the second subset, allowing the second subset to include features that are not highly ranked with respect to contributions in the first subset.

The selected subsets are then outputted with attributes of features in the subsets (operation 312). For example, feature names and/or feature values of the features may be outputted, along with values of the corresponding local and global contributions and/or metrics (e.g., proportions, percentiles, etc.) associated with the contributions or feature values. The outputted data may be used to characterize both the local and global behavior, performance, or output of the statistical model.

Model performance may continue to be characterized (operation 314) with respect to different sets of feature values and the corresponding output values. For example, the performance of the statistical model may be characterized for each of a set of predictions, scores, or inferences made by the statistical model. If the performance of the statistical model is to be characterized with remaining sets of feature and output values, a different set of local contributions is calculated for each set of feature values (operation 306), and subsets of features with the highest local and global contributions are selected from the corresponding rankings (operations 308-310). The selected subsets of features and the corresponding attributes are then outputted (operation 312). Operations 306-312 may be repeated until the performance of the statistical model is characterized with respect to all relevant sets of feature values.

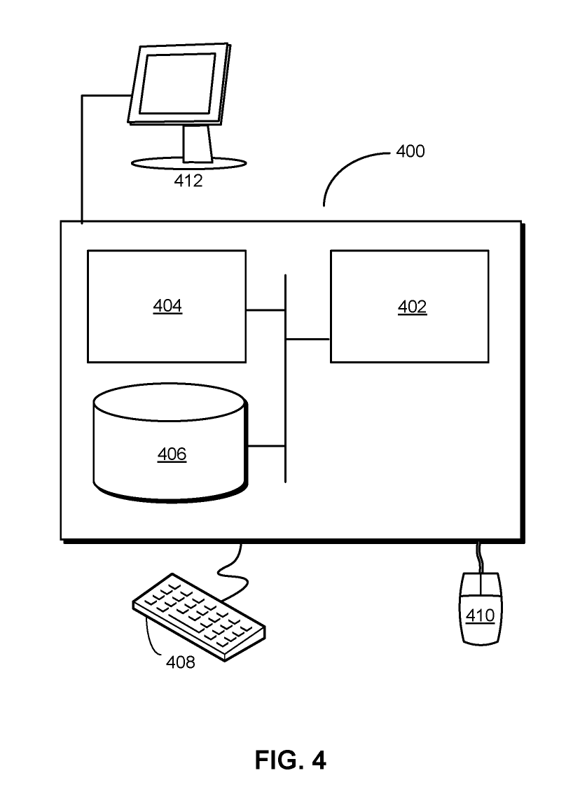

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system may include an analysis apparatus and a management apparatus, one or more of which alternatively be termed or implemented as a module, mechanism, or other type of system component. The analysis apparatus obtains a set of coefficients from a linear model that uses a set of features inputted into a statistical model to estimate an output of the statistical model. Next, the analysis apparatus combines the set of coefficients with a set of feature values of the features to obtain a set of local contributions of the features toward the output of the statistical model. The management apparatus then outputs a first subset of the features with highest local contributions toward the output of the statistical model for use in characterizing a local performance of the statistical model. The management apparatus also outputs a second subset of the features with highest coefficients from the linear model for use in characterizing a global performance of the statistical model.

In addition, one or more components of computer system 400 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that uses a linear model and different sets of feature values to characterize the local and global performance of a remote statistical model.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A system, comprising:
one or more processors; and
memory storing instructions that, when executed by the one or more processors, cause the system to:
obtain a set of coefficients from a linear model that uses a set of features inputted into a statistical model to estimate an output of the statistical model;
combine the set of coefficients with a set of feature values of the features to calculate a set of local contributions of the features toward the output of the statistical model, wherein each local contribution in the set of local contribution is calculated by multiplying each feature value in the set of feature values by a coefficient for a corresponding feature in the linear model; and
output, based on a first ranking of the set of features by the set of local contributions, a first subset of the features for use in characterizing a local performance of the statistical model.

2. The system of claim 1, wherein the memory further stores instructions that, when executed by the one or more processors, cause the system to:
output, based on a second ranking of the set of features by measures of feature importance from the statistical model, a second subset of the features for use in characterizing a global performance of the statistical model.

3. The system of claim 2, wherein the memory further stores instructions that, when executed by the one or more processors, cause the system to:
select the first and second subsets of the features based on one or more parameters used to determine numbers of features to be included in the first and second subsets of features.

4. The system of claim 3, wherein the one or more parameters comprise a parameter for placing a feature in the first or second subset of the features.

5. The system of claim 3, wherein the one or more parameters comprise a proportion associated with the numbers of features to be included in the first and second subsets of features.

6. The system of claim 1, wherein the memory further stores instructions that, when executed by the one or more processors, cause the system to:
build the linear model using multiple sets of feature values for the set of features and multiple output values from the statistical model.

7. The system of claim 1, wherein the memory further stores instructions that, when executed by the one or more processors, cause the system to:
output one or more attributes associated with the first subset of features.

8. The system of claim 1, wherein the one or more attributes comprise:
a feature value; and
a quantile associated with the feature value.

9. The system of claim 1, wherein the first subset of the features is associated with higher local contributions than a second subset of the features that is not outputted for use in characterizing the local performance of the statistical model.

10. A method, comprising:
obtaining a set of coefficients from a linear model that uses a set of features inputted into a statistical model to estimate an output of the statistical model;
combining, by one or more computer systems, the set of coefficients with a set of feature values of the features to calculate a set of local contributions of the features toward the output of the statistical model, wherein each local contribution in the set of local contribution is calculated by multiplying each feature value in the set of feature values by a coefficient for a corresponding feature in the linear model; and
outputting, based on a first ranking of the set of features by the set of local contributions, a first subset of the features for use in characterizing a local performance of the statistical model.

11. The method of claim 10, further comprising:
outputting, based on a second ranking of the set of features by measures of feature importance from the statistical model, a second subset of the features for use in characterizing a global performance of the statistical model.

12. The method of claim 11, further comprising:
selecting the first and second subsets of the features based on one or more parameters used to determine numbers of features to be included in the first and second subsets of features.

13. The method of claim 12, wherein the one or more parameters comprise at least one of:
a parameter for placing a feature in the first or second subset of the features; and
a proportion associated with the numbers of features to be included in the first and second subsets of features.

14. The method of claim 10, further comprising:
building the linear model using multiple sets of feature values for the set of features and multiple output values from the statistical model.

15. The method of claim 10, further comprising:
outputting one or more attributes associated with the first subset of features.

16. The method of claim 15, wherein the one or more attributes comprise:
a feature value; and
a quantile associated with the feature value.

17. The method of claim 10, wherein the first subset of the features is associated with higher local contributions than a second subset of the features that is not outputted for use in characterizing the local performance of the statistical model.

18. A non-transitory computer-readable storage medium storing instructions that when executed by a computer cause the computer to perform a method, the method comprising:
obtaining a set of coefficients from a linear model that uses a set of features inputted into a statistical model to estimate an output of the statistical model;
combining the set of coefficients with a set of feature values of the features to calculate a set of local contributions of the features toward the output of the statistical model, wherein each local contribution in the set of local contribution is calculated by multiplying each feature value in the set of feature values by a coefficient for a corresponding feature in the linear model; and
outputting, based on a first ranking of the set of features by the set of local contributions, a first subset of the features for use in characterizing a local performance of the statistical model.

19. The non-transitory computer-readable storage medium of claim 18, wherein the method further comprises:
outputting, based on a second ranking of the set of features by measures of feature importance from the statistical model, a second subset of the features for use in characterizing a global performance of the statistical model.

20. The non-transitory computer-readable storage medium of claim 18, wherein the method further comprises:
selecting the first and second subsets of the features based on one or more parameters used to determine numbers of features to be included in the first and second subsets of features.
